(19) United States
(12) Patent Application Publication
(10) Pub. No.: US 2008/0015965 A1
(43) Pub. Date: Jan. 17, 2008

(54) METHOD AND SYSTEM FOR TRADING TANGIBLE AND INTANGIBLE GOODS

(76) Inventors: Kai Huang, Gladwyne, PA (US); Gerald Dennis O'Connell, Berwyn, PA (US); Patrick Robert McCauley, Malvern, PA (US)

Correspondence Address: FISH & RICHARDSON P.C., P.O. BOX 1022, MINNEAPOLIS, MN, 55440-1022, US

(21) Appl. No.: 11/424,508

(22) Filed: Jun. 15, 2006

(51) Int. Cl. G06Q 40/00

(52) U.S. Cl. 705/37

(57) ABSTRACT

An electronic trading system and method is used to buy and sell goods. Buyers and sellers use the trading system and the system provides anonymous trade-interest access to both buyers and sellers.

### TECHNICAL FIELD

This invention relates to methods and systems for trading goods and/or rights, and more particularly to methods and systems for trading, for example, securities.

### BACKGROUND

The trading systems market includes a number of products and services for executing trades of various tangible or intangible goods. For example, a number of products and services have been developed for trading securities such as stocks, bonds and the like. In some cases, products and services are particularly directed to trade “blocks” of securities or other goods, in volumes above a given minimum volume or with other such restrictions on volume.

In certain situations, buyers and sellers of tangible or intangible goods, for example securities, prefer anonymous access to information about potential complimentary interest, as well as anonymous execution of trades. This may be preferred in particular when executing block-sized transactions. Buyers and sellers also generally prefer low-cost mechanisms for executing transactions of securities or other goods. There is thus a need for a system and method for trading tangible or intangible goods, wherein the trade may take place anonymously between buyers and sellers and the existence of intent by buyers and sellers may be mutually disclosed through the system.

### SUMMARY

According to an embodiment of the invention, a trading system comprises a trade-interest entry engine configured to receive a trade-interest and a contra-side trade-interest; a trade-interest matching engine configured to match trade-interests received by the trade-interest entry engine; and an alert generating engine.

According to another embodiment, a trading system comprises a trade-interest entry engine configured to receive a trade-interest and a contra-side trade-interest; a trade-interest matching engine configured to match trade-interests received by the trade-interest entry engine; an alert generating engine; and an anonymous blind auction engine configured to be activated when the trade-interest matching engine identifies near-complementary trade-interests

According to another embodiment, a trading system comprises a trade-interest entry engine configured to receive a plurality of trade-interests, wherein at least one trade-interest comprises an indication of interest; a trade-interest matching engine configured to match trade-interests received by the trade-interest entry engine; an alert generating engine; and an anonymous blind auction engine configured to be activated when the trade-interest matching engine matches an indication of interest with a contra-side trade-interest.

According to another embodiment, a trading system comprises a trade-interest entry engine configured to receive a trade-interest and a contra-side trade-interest, wherein at least one of the trade-interests is an indication of interest; a trade-interest matching engine configured to match trade-interests received by the trade-interest entry engine; an alert generating engine configured to notify a subscriber that a near-complementary trade-interest exists; and an anonymous blind auction engine configured to be activated when the trade-interest matching engine identifies near-complementary trade-interests.

According to another embodiment, a method of trading a good comprises receiving a trade-interest and a contra-side trade-interest; determining whether the trade-interest and the contra-side trade-interest are matchable; generating an alert when at least one of the matchable trade-interest and contra-side trade interest comprises an indication of interest; and activating an anonymous blind auction to trade the good.

According to another embodiment, a method of trading a good comprises receiving a first trade-interest for the good in the form of an order from a subscriber via a trade-interest entry engine; receiving a contra-side trade-interest from a second subscriber via the trade-interest entry engine, wherein the contra-side trade-interest comprises an indication of interest for the good; determining whether the trade-interest and the contra-side trade-interest match through use of a trade-interest matching engine; providing an alert, via an alert generating engine, to at least one of the first subscriber and the second subscriber when the trade-interest and the contra-side trade-interest are matchable; and providing an opportunity for the first and second subscriber to participate in an anonymous blind auction to trade the good.

According to another embodiment, a trading system comprises a trade-interest entry engine configured to receive a plurality of trade interests; a trade-interest matching engine configured to match trade-interests received by the trade-interest entry engine; an alert generating engine configured to notify a subscriber that a near-complementary trade-interest exists; an anonymous blind auction engine configured to be activated when the trade-interest matching engine identifies near-complementary trade-interests; and a mechanism for executing a trade configured to be activated when the trade-interest matching engine identifies complementary trade-interests that are orders.

According to another embodiment, a method of trading a good comprises receiving a trade-interest and a contra-side trade-interest; determining whether the trade-interest and the contra-side trade-interest are matchable; generating an alert when at least one of the matchable trade-interest and contra-side trade interest comprises an indication of interest; activating an anonymous blind auction to trade the good when at least one of the matchable trade-interest and contra-side trade interest comprises an indication of interest; and executing a trade anonymously when trade-interests that are complementary orders are matched.

The details of these and other non-limiting, exemplary embodiments of the invention are set forth in the accompanying drawings and the description below. Other features, objects, and advantages of the invention will be apparent from the description and drawings, and from the claims.

### DESCRIPTION OF DRAWINGS

FIG. 1 is a flow chart of the trading system.

FIG. 2 is a schematic diagram of a computer system.

### DETAILED DESCRIPTION

An electronic trading system is used to buy and sell tangible or intangible goods. Such goods may include: securities, for example, stocks, bonds, mutual funds, options, futures and the like; tangible goods such as commodities or other physical items; real property or real estate; services; or anything else that is purchasable. It is understood that the term “goods” as used herein is to be construed broadly, including all such elements of the previous list, as well as anything else, tangible or intangible, that may be bought or sold.

Buyers or sellers may utilize the trading system. In an exemplary embodiment, buyers or sellers may register to use the system in any suitable manner as known in the art. Alternatively, the system may be used for onetime use without having to register or be a subscriber. The term “subscriber” as used herein is understood to be construed broadly, for example to encompass both buyers and sellers who register or subscribe to use the system, as well as buyers and sellers who utilize the described system or method but do not otherwise register or pre-subscribe to the system.

The system provides anonymous information, order access, and/or order execution to subscribers who are buyers or sellers or who are both buyers and sellers. When used for trading securities, the system and method preferably comply to any applicable rules and regulations of the Securities Exchange Commission (SEC). Exemplary embodiments described herein generally conform to a number of such rules and regulations in effect as of the date this application was filed. It is understood that modifications may be made based on changes in the rules and regulations, and such modifications are within the scope of the subject matter described herein.

Subscribers may include, for example, subscribers who are broker-dealers and subscribers who are non-broker-dealers. As used herein, broker-dealers include entities registered as broker-dealers under Section 15 of the Securities Exchange Act of 1934 and any other entities that act on the system in a capacity that is deemed to constitute market making or who otherwise act in a “sell side” capacity, even if such entities are not called or known as “market makers.” Broker-dealers may trade, for example as a principal or as an agent. Broker-dealers may also be referred to as “sell-side” subscribers. With regard to the trading method and trading system herein, based on current SEC regulations, subscribers who are broker-dealers are included in a class of non-qualified subscribers and may enter trade-interests in the form of orders into the system. Alternatively, if regulations change in the future, it is understood that subscribers who are broker-dealers may be included in a class of qualified and/or non-qualified subscribers, and broker-dealer subscribers may enter trade-interests in forms other than orders.

Non-broker-dealers include entities that are not registered as broker-dealers under Section 15 of the Securities Exchange Act of 1934 and do not act on the system in a capacity that is deemed to constitute market making. As understood in the art, a “market maker” refers to an entity that stands ready to buy and sell a particular security on a regular and continuous basis at a publicly quoted price, i.e., a price within regulated parameters.

Examples of non-broker-dealers include, without limitation, entities such as mutual funds, pension funds, hedge funds, insurance companies and corporations. Non-broker-dealers may also be referred to as buy-side subscribers. With regard to the trading method and trading system herein, and in accordance with current SEC regulations, subscribers who are non-broker-dealers are included in a class of qualified subscribers and may enter orders and IOIs into the system and may receive alerts from the system of contra-side trade-interests. Again, it is understood that if the SEC regulations change in the future, non-broker-dealers may be qualified and/or non-qualified subscribers.

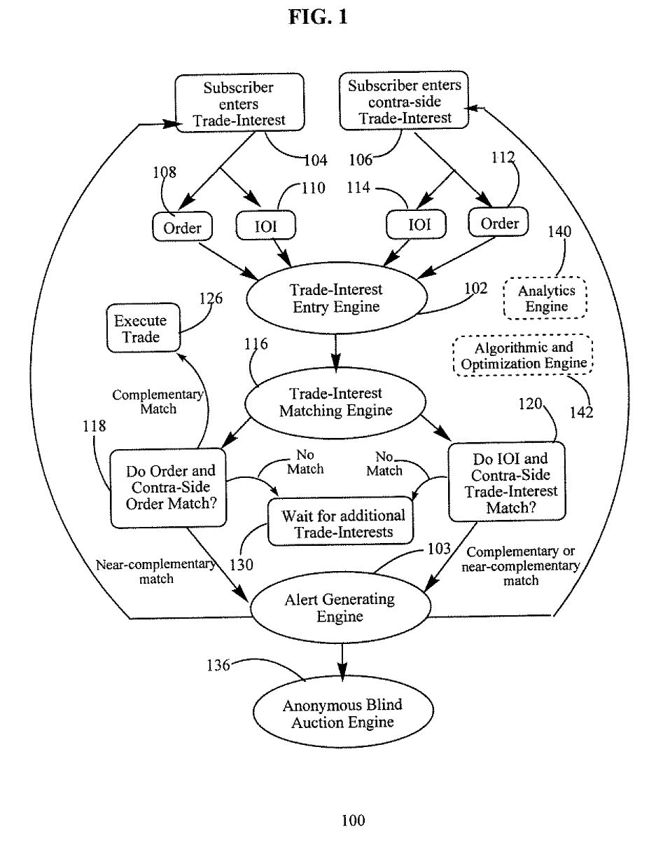

As shown in FIG. 1, a trading system 100 comprises a trade-interest entry engine 102, a trade-interest matching engine 116, an alert generating engine 103, and an anonymous blind auction engine 136. The trading system 100 may further include an optional analytics engine 140.

As used herein, the term “engine” is understood to mean any electrical or electronic component that may process information, such as a computer or other processor running software, whether alone or residing within a network. One or more engines described herein may be present on a single computer or network. Alternatively, one or more engines may reside on different computers or networks, or a single engine may function as a distributed program running on a number of processors, computers or networks, as understood in the art. As another alternative, engines described herein may be incorporated into or combined so that an engine performs multiple functions. The terms “processor,” “computer,” and “network” are understood to be construed broadly, as understood in the art, and no particular form should be understood as a limitation on the invention. Similarly, the term “software” is also understood to include all computer code, including executable code, in any useful program language, and should not be construed as a limitation on the invention.

Referring to FIG. 1, the trade-interest entry engine 102 may be configured to receive a trade-interest from a first subscriber and a contra-side trade-interest from another subscriber. A trade-interest includes, but is not limited to, market orders, limit orders, and indications of interest (IOIs). As understood in the art, a “market order” is an order to buy or sell a good at the current market price. A “limit order” is an order to buy or sell a good at a specific price. A buy limit order can be executed at the limit price or lower, and a sell limit order can be executed at the limit price or higher. An IOI serves to examine information within the system 100 for the existence of contra-side trade-interests, e.g., contra-side orders and contra-side IOIs. “Contra-side” is used herein to refer generically to a trade-interest that is complementary to another trade-interest. It is understood that a contra-side trade-interest need not be a contra-side trade interest when entered into the trade-interest entry engine 102, and the trade-interest matching engine 102, as described herein, determines whether a trade-interest is a contra-side trade-interest when determining whether trade-interests entered into the system 100 are matchable.

In the embodiment of FIG. 1, the trade-interest entry engine 102 receives a buy trade-interest 104 from a buyer and a sell trade-interest 106 from a seller. As shown in the figure, for example, the trade-interests entered are orders 108, 112 and IOIs 110, 114. After the order 108, 112 or IOI 110, 114 is entered into the system 100, a trade-interest matching engine 116 may match complementary or near-complementary trade-interests in the trading system.

The trade-interest matching engine 116 compares the entered trade-interest and contra-side trade-interest to determine whether the interests are matchable 118, 120. In an exemplary embodiment, trade-interests generally match, or are matchable, when the subject matter and/or price and/or size of the trade-interest and contra-side trade-interest are/is complementary or near-complementary. A complementary match is one where the trade-interest and contra-side trade-interest are counterparts, i.e., the subject matter and price of the trade-interests are the same and the size of the trade-interests are at least the same (it being understood that one of the trade-interests may be larger than the other). A near-complementary match is one where the trade-interest and contra-side trade-interest have at least one, but not all three, of the subject matter, price, and size as the same or similar. The trade-interest matching engine 116 may comprise an algorithm configured to match trade-interests received by the trade-interest entry engine 102 according to pre-determined priority criteria.

In the illustrated embodiment, if the trade-interest and contra-side trade-interest are both orders and they are complementary, then the system 100 executes a trade 126. Thus, if the buyer's order 108 matches the seller's order 112, the trade-interest matching engine 116 determines a match exists 118 and a trade may be executed 126 by the system 100. If two or more matchable trade-interests are orders, the trade-interest matching engine 116 may also match at least one order with one or more contra-side orders that are in the system 100. In an exemplary embodiment, the system 100 includes a mechanism for executing the trade anonymously so that neither the buyer nor seller of the good knows the other's identity.

In an exemplary embodiment, when the trade-interest placed by the subscriber is a market order, the matching may occur and a trade may be executed if there is a contra-side order that is a complimentary market order or a limit order wherein the limit is at or within the then-current National Best Bid and Offer (“NBBO”). As understood in the art, the NBBO is an expression applying to the SEC requirement that brokers must guarantee customers the best available ask price when they buy securities and the best available bid price when they sell securities. The NBBO is updated throughout the day to show the highest and lowest offers for a security in all exchanges and market makers.

When the trade-interest placed by the subscriber is a limit order, the matching may occur, and a trade may be executed if there is (a) a contra-side order that has a matching limit, or (b) a contra-side market order, and the limit price of the limit order is at or within the NBBO. In an exemplary embodiment, if permitted under SEC rules and regulations, and exemptions therefrom, trading through the NBBO may take place. In this exemplary embodiment, trading may occur outside the NBBO, similar to an alternative trading system (“ATS”) which is currently governed by Regulation ATS.

Referring to FIG. 1, if the trade-interest matching engine 116 determines that the trade-interest and contra-side trade-interest do not match 120, in one scenario, the system 100 waits for an additional interest to be entered into the trade-interest entry engine 102. As a non-limiting example, if the order matching engine 116 determines that the buyer's order 108 and the seller's order 112 do not match 120, the system 100 waits for additional trade-interests to be entered 130. As a consequence, if the trade-interest matching engine 116 is unable to match trade-interests, subscribers may have the opportunity to participate in a new round of submitting trade-interests at one or more different price levels via the trade-interest entry engine 102.

A different situation may arise when a trade-interest and contra-side trade-interest are complementary or near-complementary, but one or both of the interests are not orders. In an exemplary embodiment, when an IOI is placed, for example, the alert generating engine 103 may send an alert to all subscribers who have at least a contra-side trade-interest at, within, or near the then-current NBBO of the goods that are the subject matter of the IOI. In another exemplary embodiment, the alert may be sent to any subscriber with a trade-interest in the same subject-matter of the IOI, regardless of the price or NBBO.

In addition, an alert may be provided to the subscriber who placed the IOI, notifying that subscriber of any contra-side interests. Having received such alerts, the subscriber placing the IOI and the contra-side subscribers having an interest in the goods may engage in an anonymous blind auction, wherein values for quantity and price for the goods entered by a subscriber may not be disclosed to other subscribers on the system, through activation of an anonymous blind auction engine 136.

In an exemplary embodiment, the auction is an anonymous blind Dutch auction. “Dutch auction,” as used herein refers to a trade process that employs a bidding process to find an optimal market price for a good, the lowest price at which an issuing entity can sell a predetermined number of goods. “Blind Dutch auction” refers to a Dutch auction wherein parties to a potential transaction are anonymous. In other exemplary embodiments, the auction is an English auction, a multi-unit English ascending auction, a sealed high-bid auction, a first-price sealed-bid auction, a procurement auction algorithm, a unique trade auction, a buy-out auction, or combinatorial auction.

In a further exemplary embodiment, parties to a transaction are not notified of unexecuted trade-interests, but rather are notified when a transaction can be executed based on matching of an order and a contra-side order.

Referring to FIG. 1, when the trade-interest matching engine 116 determines that an IOI 110, 114 and a complementary order 112, 108 have been received by the trade-interest engine 102, an alert generating engine 103 provides an alert to one or both of the subscribers who entered the matching IOI and order. The alert generating engine 103 may base whether to send an alert on the subject good, price, or some other metric with at least one other trade-interest. Alerts may be provided to subscribers who have an interest in the subject matter of the IOI, as determined by the trade-interest matching engine 116, 120. After the alert generating engine 103 sends the alert, one or both of the subscribers may change their trade-interests through the trade-interest entry engine 102.

The alert may comprise any useful form, for example an e-mail, a text message, a phone call, a sound, and the like and/or a color, graphic, alphanumeric character, a link, a pop-up, a window, a dialog box, text, and the like, and/or combinations thereof. According to an exemplary embodiment, the system 100 may display a blotter and provide an alert that is superimposed on or integrated or incorporated into the blotter.

In an exemplary embodiment, the alert may inform the subscriber placing the order or IOI whether the contra-side interest is in the form of an order or in the form of an IOI. The alert may or may not provide the price or quantity values for the contra-side order. Also, when the trade-interest placed by the subscriber is an IOI, the alert to the subscriber placing the IOI may identify whether the contra-side trade-interest is priced at or within the NBBO.

Referring again to the non-limiting example of FIG. 1, after receiving an alert from the alert generating engine 103, the subscriber who placed the IOI may change the IOI to a market order or a limit order via trade-interest entry engine 102. If the IOI is changed to a market order, it may be matched by the trade-interest matching engine 116 so that a transaction may be executed 118, 126. If the IOI is changed to a limit order through use of the trade-interest entry engine 102, an execution match as determined by the trade-interest matching engine 116 may occur if the limits are matchable 118, 126. If the limits are not matchable, the subscriber who entered the trade-interest and/or the subscriber who entered the contra-side trade-interest could, for example, cancel the unmatchable limit order and replace the order by entering either a market order or a limit order having a different limit into the trade-interest entry engine 102 until a match occurs as determined by the system 100.

The process of obtaining an executable transaction by changing the IOI to a limit order and subsequently changing the limit may be iterative in the described system. Preferably, regardless of how many changes are made to an order during such a process, anonymity is preserved, i.e., the identity of the subscriber and the price and size of the unexecuted interest are not divulged to the contra-side subscriber.

The obtaining of matched orders may optionally be carried out by the subscribers via an auction. As shown in FIG. 1, the system 100 is equipped with an anonymous blind auction engine 136 that may be activated when an IOI and a contra-side trade-interest (which may be an order or an IOI) are matched by the trade-interest matching engine 116. The anonymous blind auction engine 136 may be a secure and private program that accesses IOIs from subscribers and may allow subscribers with complementary interests to facilitate a transaction. The anonymous blind auction engine 136 may use a template, which may optionally be standardized. In one exemplary embodiment, if 15 subscribers have each entered a trade-interest, 10 of which are deemed to be near-complementary with one another by the trade-interest matching engine 116, and these 10 subscribers decide to participate in an auction through use of the anonymous blind auction engine 136, the 10 subscribers participating in the auction may use their respective templates to enter trade-interests for the auction; each of these 10 subscribers will not see the other entered trade-interests, and the 5 subscribers who have not received an alert are neither aware of or involved in the auction.

In an exemplary embodiment, the alert generating engine 103 may be configured to provide a qualified subscriber that entered an order or IOI and the subscriber that entered an IOI an option to participate in an anonymous blind auction by accessing an order template via the anonymous blind auction engine 136. In another exemplary embodiment, the order template may automatically appear without the subscribers' having to elect to participate in a blind auction. According to an exemplary embodiment of an order template, a symbol and a particular subscriber's interest as a buyer or seller (or other metrics) may already be pre-completed on a computer screen or other display of each participating subscriber. Thus each participating subscriber may complete the order template by, for example, specifying the price and size of an order and submitting that order into the trading system in an effort to be matched with a contra-subscriber through the anonymous blind auction engine 136.

In this exemplary embodiment, the alert generating engine 103 and the anonymous blind auction engine 136 may not disclose the identity of other participants in the blind auction trying to complete a transaction. Also, the alert generating engine 103 and the order template may not disclose the sizes or prices of other orders entered. The information provided to subscribers may include information that there exists on the system 100 a trade-interest in the same good and that there is a subscriber that has entered a contra-side trade-interest (i.e., if a subscriber has entered a buy order for a security, then that subscriber may be informed the there is a subscriber that has entered a sell order for the same security).

If, either through use of the anonymous blind auction engine 136 or by changing the IOI to an order via the trade-interest entry engine 102, the subscriber entering an order and the subscriber entering the contra-side order come to agreement regarding the terms of the transaction, the transaction may be executed 126 and the transaction may be cleared and processed through an optional back office system. The back office system may perform a number of functions, including, but not limited to, clearing a transaction, processing a transaction, monitoring a regulatory requirement, monitoring a compliance requirement, and/or any other function suitable for a back office system to perform.

It is understood that, in an exemplary embodiment, if an additional subscriber entered a trade-interest in the trade-interest entry engine 102 that matches the order placed by either the subscriber who entered the trade-interest or the subscriber who entered the contra-side trade-interest via trade-interest entry engine 102, then the additional subscriber's trade-interest entry and its contra-side trade-interest may result in an executed trade. In an exemplary embodiment, if an additional subscriber entered a trade-interest in the trade-interest entry engine 102 that matches the order placed by either the subscriber who entered the trade-interest or the subscriber who entered the contra-side trade-interest via the anonymous blind auction engine 136, then the additional subscriber's trade-interest entry and its contra-side trade-interest may optionally result in an executed trade. If an additional subscriber's trade-interest and its contra-side trade-interest results in an executed trade, the subscriber who was not a party to the trade may have to wait until the order matching engine 116 finds another contra-side trade-interest to complete a transaction. In this exemplary manner, the system 100 may be configured to permit subscribers to participate in a blind Dutch auction in order to execute a transaction.

In another exemplary embodiment, the system 100 may include an optional analytics engine 140 that supports at least one additional service for subscribers, including, but not limited to, pre-and post-trade metrics and algorithmic trade services.

Exemplary methods of using the system 100 are now described.

In one scenario, referring to FIG. 1, a first subscriber enters via the trade-interest entry engine 102 a trade-interest 104. A second subscriber enters via the trade-interest entry engine 102 a trade-interest 106. When the first subscriber's trade-interest is an order 108, and the second subscriber's trade-interest is an order 112 that matches the first subscriber's order as determined by the trade-interest matching engine 116, a trade may be executed 126, and in an exemplary embodiment, the trade may be executed anonymously. Likewise, it is understood that more than two subscribers may enter orders into the system 100 through use of the trade-interest entry engine 102; the trade-interest matching engine 116 may monitor the entered trade-interests to determine whether any complementary or near-complementary trade-interests and contra-trade interests exist.

In another exemplary embodiment, when the first or second subscriber's order is an IOI 110, 114, the trade-interest matching engine 116 searches the contra-side trade-interest entries to determine whether there is a match or pairing or near match or pairing at block 120. If a match exists, the subscriber who entered the IOI will receive an alert generated from the alert generating engine 103. Alternatively, if only one subscriber entered an IOI, either both subscribers or the one who did not enter the IOI may receive an alert generated from the alert generating engine 103.

In response to the alert, the subscriber who entered the IOI may use the order entry engine 102 to change the IOI to a matching contra-side order so that a trade can be executed 126 after the trade-interest matching engine 116 determines there is a match. Alternatively, the subscriber who entered the IOI may communicate to the contra-side subscriber via the anonymous blind auction engine 136.

If the anonymous blind auction engine 136 is activated, a private message template, which may optionally be standardized, may be used for the subscribers to participate in an anonymous blind auction. According to an exemplary embodiment of an order template, a symbol and a particular subscriber's interest as a buyer or seller may already be pre-completed on the template. Thus each participating subscriber may complete the order template by, for example, specifying the price and size of an order and submitting that order into the trading system in an effort to be matched with a contra-subscriber in the anonymous blind auction.

Subscribers using either the order entry engine 102 or anonymous blind auction engine 136 may result in a change in the contra-side IOI to a matching contra-side order. In either scenario, after receiving the matching contra-side order, the system 100 may then compare via the trade-interest matching engine 116 the order to the matching contra-side order. After the trade-interest matching engine 116 determines a match exists, a trade may be executed 126.

If, on the other hand, after receiving an alert the first and second subscriber are unable to complete a transaction, the system 100 may wait for additional contra-side orders and repeat block 116 until a match is found.

According to an exemplary embodiment, subscribers may be divided into two or more classes of qualified and non-qualified subscribers, wherein at least one class may be more restricted than other classes in its ability to access certain functions of the trading system. As described above, an exemplary division under current SEC rules identifies subscribers as either broker-dealers or non-broker-dealers.

In another exemplary embodiment, entry of an IOI into the system 100 is available to qualified subscribers. In this embodiment, a first subscriber enters an IOI via the trade-interest entry engine 102. The trade-interest matching engine 116 searches the contra-side trade-interest entries to determine whether there is a match at block 120. The alert generating engine 103 provides an alert to qualified subscribers who have an interest in the subject matter of the first subscriber's IOI that an IOI has been received for the same subject matter. The alert generating engine 103 also provides an alert to the first subscriber when there is a contra-side interest.

Having received the alert, a qualified subscriber may place an order for the good in the system 100 via the trade-interest entry engine 102. Also, the first subscriber, who placed the IOI, having received the contra-side interest alert, may place an order for the good in the system 100 via the trade-interest entry engine 102, i.e., change the IOI to an order. The system 100 may then compare via the trade-interest matching engine 116 the first subscriber's order to the qualified subscriber's contra-order. If a match is obtained at block 118, a trade may be executed at block 126. If a match does not exist, then the system 100 may wait for an additional contra-side order to be entered via the trade-interest entry engine 102 and repeat block 116 or the subscribers may elect to participate in a blind auction through use of the anonymous blind auction engine 136 to try to reach an agreement by entering more aggressive price metrics.

The term “order” has been used throughout the description. It is understood that an order is a request to buy or sell a good. An order may be a single order, a plurality of orders, a block order, or any other type of order that is capable of effectuating a trade. A “block order,” also called a “block trade” as used herein, refers to a set of like goods, such as shares of stock, which are bought, sold or handled as a unit. For example, a large amount of the same security bought or sold by institutional or other large investors may be referred to as a block order. According to some embodiments, a block order of securities may be at least 10,000 equity shares. According to some embodiments, a block order of securities may be at least 25,000 equity shares. According to some embodiments, a block order of securities may have a value at least $100,000. According to some embodiments, a block order of securities may have a value at least $200,000. It is understood that the amount of goods in the “block” can vary from the amounts set forth herein.

In an exemplary embodiment, when a subscriber places an IOI, the alert generating engine 116 may send an alert informing all subscribers or all contra-side subscribers who have an established interest in the security that is the subject of the IOI that an IOI has been placed. In one exemplary embodiment, the alert generating engine 116 may send the alert to those subscribers whose established interest in the security is at or within the then-current NBBO for that security. According to another exemplary embodiment, when a subscriber places an IOI, an alert may be provided to all subscribers or all contra-side subscribers who have an established interest in a security similar to that which is the subject of the IOI. A similar security may be for example a security in the same business, industry or sector as the security that is the subject of the IOI.

Subscribers may access the system 100 via a computer. The subscribers may be required to “logon” in order to access the system. In one embodiment, the trading system may be Internet-based. As described herein, reference may be made to a particular Internet-based embodiment. It is understood, however, that other systems or mechanisms may be used, for example local area or wide area networks, other restricted or open networks of computers or processors, and protocols other than TCP/IP (Transmission Control Protocol/Internet Protocol) protocols commonly utilized with the Internet. It is also understood that other Internet-based systems may be utilized, and that the embodiment described herein should not be construed as a limitation on the invention.

The trading system 100 may operate as an electronic, substantially automated trading system for equity securities. In this situation, the system may operate as a broker-dealer, governed by rules outlined in the SEC Regulation ATS. Generally, Regulation ATS permits the organization of certain types of market facilities (exempt from security exchange regulations) designed to bring together the trade-interests of multiple buyers and sellers. When the trading system is used for trade securities, securities may be tiered based on average daily volume, market capitalization, stock price and/or volatility of each security.

If SEC regulations permit or an exemption from the SEC is obtained, the trading system 100 may include algorithmic and optimization services through use of an algorithmic and optimization engine 142. It may offer electronic “sales/trader” functionality that permits customers to enter live, executable orders in the system. As non-limiting examples, subject to instructions from the buyer and/or seller, (a) part of an order may be routed for execution to at least one separate exchange or separate trading system available in the marketplace, using available algorithmic trading engines available in the marketplace (including, without limitation, volume weighted average price (VWAP), percentage of volume, proprietary trading algorithms, etc.) while the remaining part of the order may be eligible for matched execution on the system 100; (b) the system 100 may process the order and if the system 100 cannot match all or part of an order, then that unmatched part of the order may be routed for execution to at least one separate exchange or separate trading system available in the marketplace, using available algorithmic trading engines available in the marketplace (including, without limitation, VWAP, percentage volume, proprietary trading algorithms, etc.); or (c) at least part of an order (i.e., a part or all of an order) may be routed for execution to at least one separate exchange or separate trading system available in the marketplace, using available algorithmic trading engines available in the marketplace (including, without limitation, VWAP, percentage volume, proprietary trading algorithms, etc.), the system 100 may continue to match some or all of that same portion of the order, and whichever is able to match any portion of the order first executes the trade for such portion, with any remainder of the order to continue to be worked in the same way, if desired, until the order is completely filled. Accordingly, the trading system 100 may be configured to include “smart routing” and execution technology designed to receive trade-interests with multiple levels of execution instruction from buyers or sellers and the ability to receive orders while simultaneously searching for and/or accessing block liquidity (across multiple venues).

Regarding qualified subscribers, software integrated with the trading system 100 may selectively transmit trade-interests in the trading system 100 to an electronic trade network as an IOI or an order. Communication software may allow anonymous communication between buyers and sellers. Regarding parties who are non-qualified subscribers, software may be integrated with the trading system 100 to transmit orders in the trading system 100 to the electronic trade network. The electronic trade network may continuously run a matching algorithm. For the matching orders, a crossing trade may be generated and reported to the proper marketplace. For the matching IOIs, qualified subscribers may be contacted so that they may optionally engage in an anonymous communication.

If SEC regulations or an SEC exemption permit, buyers and sellers may be able to access at least one trading algorithm through the trading system 100.

Several trading algorithms are well-known and include, but are not limited to, Dutch auction algorithms, English auction algorithms, multi-unit English ascending auction algorithms, sealed high-bid auction algorithms, first-price sealed-bid auction algorithms, procurement auction algorithms, unique trade auction algorithms, buy-out auction algorithms, combinatorial auction algorithms, pro-rata trade algorithms, pattern algorithms, genetic algorithms, and the like.

The system may include trade metrics, which are understood by one of ordinary skill in the art to be a plurality of methods to analyze and/or evaluate transactions, including, but not limited to, trade cost analysis, advice on optimal trade strategy (pre-execution), advice on algorithmic method of execution, advice on hedging techniques, and portfolio execution optimization.

Pre- and post-market hour crossing capabilities, which may incorporate a trade protocol, and functionality, such as alerts or pre-determined trading strategies, based on news and earnings announcement outside regular market hours may also be included in the trading system.

Having described different exemplary embodiments above, the following description sets forth additional exemplary embodiments based on current SEC rules and regulations:

According to an exemplary embodiment, both qualified or buy-side and non-qualified or sell-side subscribers may submit trade-interests in the form of orders, e.g., market orders and limit orders, and qualified subscribers may also submit IOIs in addition to market orders and limit orders.

According to a further exemplary embodiment, a method of trading a good comprises: (a) receiving a trade-interest for the good in the form of an order from a first subscriber via a trade-interest entry engine 102; (b) receiving a contra-side trade-interest from a second subscriber via the trade-interest entry engine 102, the contra-side trade-interest comprising an IOI for the good; (c) determining whether the trade-interest of step (a) and the contra-side trade-interest of step (b) are matchable through use of a trade-interest matching engine 116; (d) providing an alert, via an alert generating engine 103, to the first and second subscribers that enter matchable trade-interests in steps (a) and (b), informing those subscribers that there is at least one matchable trade-interest; and (e) providing an opportunity for qualified subscribers to participate in an anonymous blind auction to trade the good.

According to yet another exemplary embodiment, the method of trading a good in the previous paragraph further comprises: (f) changing by the subscriber in step (a) of the IOI of step (a) to an order; (g) matching the order obtained in step (f) to a contra-side trade-interest of step (b) via the trade-interest matching engine 116.

According to another exemplary embodiment, which may be useful with qualified subscribers as described above, a method of trading a good comprises: (a) receiving at least one IOI for a good from a qualified subscriber via a trade-interest entry engine 102; (b) receiving at least one contra-side IOI or contra-side order for the good from a subscriber via the trade-interest entry engine 102, wherein the IOI received in step (a) is matchable with the IOI or order received in step (b); (c) providing an alert, via an alert generating engine 103, to qualified subscribers that enter matchable trade-interest in step (b) and to the qualified subscriber that submitted the IOI in step (a), informing those subscribers that there is at least one matchable trade-interest in the system; and (d) providing an opportunity for qualified subscribers to participate in an anonymous blind auction to trade the good.

According to a further exemplary embodiment, participation in a blind auction to trade a good comprises: (a) entering, by subscribers having a trade-interest in the good, an order comprising price and quantity terms into a trade-interest entry engine 102; (b) determining, via a trade-interest matching engine 116, whether there is a match among the trade-interests in the good received by the trade-interest entry engine 102; (c) if there is a match, executing a trade 126 and, if there is no match, (d) repeating steps (a), (b) and (c) until either (i) a match is obtained, or (ii) a blind auction ends without obtaining a match.

According to yet another exemplary embodiment, the method of trading a good may further comprise the step of performing at least one action selected from the group consisting of clearing a transaction, processing a transaction, monitoring a regulatory requirement, and monitoring a compliance requirement.

According to another exemplary embodiment involving qualified subscribers, as described above, a method of trading a good comprises: (a) receiving an IOI for the good from a qualified subscriber via a trade-interest entry engine 102; (b) receiving a contra-side trade-interest for the good from a second subscriber via the trade-interest entry engine 102, wherein the contra-side trade-interest is an order or an IOI, and wherein when the contra-side trade-interest is an IOI, the second subscriber is a qualified subscriber; (c) determining whether the IOI of step (a) and the contra-side trade-interest of step (b) are matchable, through use of a trade-interest matching engine 116, by comparing the IOI and the contra-side trade-interest; (d) providing an alert, via an alert generating engine 103, to the first and second subscribers when matchable trade-interests for the good exist; and (e) providing an opportunity for the first subscriber and the second subscriber to participate in an anonymous blind auction to trade the good.

According to a further exemplary embodiment, participation in a blind auction to trade a good comprises: (a) changing, via the trade-interest entry engine 102, by the subscriber an IOI to an order; (b) determining, via the trade-interest matching engine 116, whether there is a match among the trade-interests in the good received by the trade-interest entry engine 102; (c) if there is a match, executing a trade 126 and, if there is no match, (d) entering, by subscribers having a trade-interest in the good via the anonymous blind auction engine 136, an order comprising price and quantity terms; (e) repeating step (b); (f) if there is a match, executing a trade 126 and, if there is no match, repeating steps (d) and (e) until either (i) there is a match, or (ii) the blind auction ends without obtaining a match.

In the system and methods set forth herein, the subscriber placing the trade-interest and the subscriber placing the contra-side trade-interest may be the same or different. As a non-limiting example, the subscriber placing the trade-interest may be an entity or person “A,” and the subscriber placing the contra-side trade-interest may be an entity or person “B.” Alternatively, the subscriber placing the trade-interest and the subscriber placing the contra-trade-interest may be the same person or entity, i.e., entity or person “A” may be the subscriber who placed both the trade-interest and the contra-trade-interest. Additionally, it is understood that the system and methods described herein may be used for more than two subscribers.

The description of the system and method has used a trade-interest and contra-side trade interest as exemplary examples for ease of understanding how the system and method work. However, the system and method are not limited to only processing one trade-interest and one contra-side trade-interest. More than two trade-interests may be entered into the system 100, and the trade-interest matching engine 116 may determine whether any of the trade-interests are matchable.

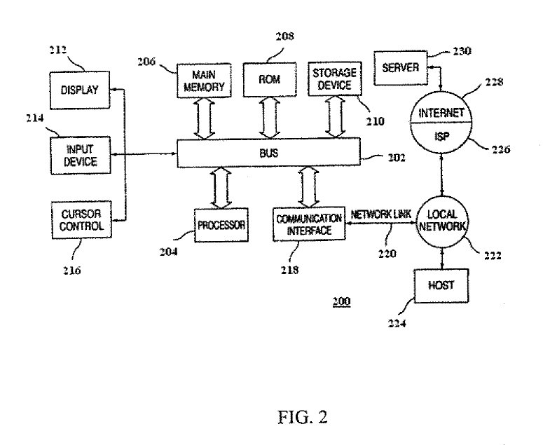

FIG. 2 illustrates an exemplary system, such as a computer system, on which the methodology described herein can be utilized. One suitable computer system upon which the method may be implemented is shown at 200. Computer system 200 includes a bus 202 or other communication mechanism for communicating information, and a processor 204 coupled with bus 202 for processing information. Computer system 200 also includes a main memory 206, such as a random access memory (RAM) or other dynamic storage device, coupled to bus 202 for storing information and instructions to be executed by processor 204. Main memory 206 also may be used for storing temporary variable or other intermediate information during execution of instructions to be executed by processor 204. Computer system 200 further includes a read only memory (ROM) 208 or other static storage device coupled to bus 202 for storing static information and instructions for processor 204. A storage device 210, such as a magnetic disk or optical disk, is provided and coupled to bus 202 for storing information and instructions.

Computer system 200 may be coupled via bus 202 to a display 212, such as a cathode ray tube (CRT), for displaying information to a computer user. An input device 214, which may include alphanumeric and other keys, is coupled to bus 202 for communicating information and command selections to processor 204. Another type of user input device is cursor control 216, such as a mouse, a trackball, or cursor direction keys for communicating direction information and command selections to processor 204 and for controlling cursor movement on display 212. This input device typically has two degrees of freedom in two axes, a first axis (e.g., x) and a second axis (e.g., y), that allows the device to specify positions in a plane.

According to one embodiment, computer system 200 operates in response to processor 204 executing one or more sequences of one or more instructions contained in main memory 206. Such instructions may be read into main memory 206 from another computer-readable medium, such as storage device 210. Execution of the sequences of instructions contained in main memory 206 causes processor 204 to perform the process steps described herein. One or more processors in a multi-processing arrangement may also be employed to execute the sequences of instructions contained in main memory 206. In alternative embodiments, hard-wired circuitry may be used in place of or in combination with software instructions to implement the methodology. Thus, practicing the methodology are not limited to any specific combination of hardware circuitry and software, and the description here and below is understood to be an exemplary embodiment of a system of the invention.

A software application containing coding for implementing the process described herein can be stored or reside in any suitable computer-readable medium. The term “computer-readable medium” as used herein refers to any medium that participates in providing instructions to processor 204 for execution. Such a medium may take many forms, including, but not limited to, non-volatile media, volatile media, and transmission media. Non-volatile media include, for example, optical or magnetic disks, such as storage device 210. Volatile media include dynamic memory, such as main memory 206. Transmission media include coaxial cables, copper wire, and fiber optics, including the wires that comprise bus 202. Transmission media can also take the form of acoustic or light waves, such as those generated during radio frequency (RF) and infrared (IR) data communications. Common forms of computer-readable media include, for example, floppy disk, a flexible disk, hard disk, magnetic tape, and other magnetic medium, a CD-ROM, DVD, any other optical medium, punch cards, paper tape, any other physical medium with patterns of holes, a RAM, a PROM, an EPROM, a FLASHEPROM, any other memory chip or cartridge, a carrier wave as described hereinafter, or any other medium from which a computer can read.

Various forms of computer-readable media may be involved in carrying one or more sequences of one or more instructions to processor 204 for execution. For example, the instructions may initially be borne on a magnetic disk of a remote computer. The remote computer can load the instructions into its dynamic memory and send the instructions over a telephone line using a modem. A modem local to computer system 200 can receive the data on the telephone line and use an infrared transmitter to convert the data to an infrared signal. An infrared detector coupled to bus 202 can receive the data carried in the infrared signal and place the data on bus 202. Bus 202 carries the data to main memory 206, from which processor 204 retrieves and executes the instructions. The instructions received by main memory 206 may optionally be stored on storage device 210 either before or after execution by processor 204.

Computer system 200 also includes a communication interface 218 coupled to bus 202. Communication interface 218 provides a two-way data communication coupling to a network link 220 that is connected to a local network 222. For example, communication interface 218 may be an integrated services digital network (ISDN) card or a modem to provide a data communication connection to a corresponding type of telephone line. As another example, communication interface 218 may be a local area network (LAN) card to provide a data communication connection to a compatible LAN. Wireless links may also be implemented. In any such implementation, communication interface 218 sends and receives electrical, electromagnetic, or optical signals that carry digital data streams representing various type of information.

Network link 220 typically provides data communication through one or more networks to other data devices. For example, network link 220 may provide a connection through local network 222 to a host computer 224 or to data equipment operated by an Internet Service Provider (ISP) 226. ISP 226 in turn provides data communication services through the worldwide packet data communication network, now commonly referred to as the “Internet” 228. Local network 222 and Internet 228 both use electrical, electromagnetic, or optical signals that carry digital data streams. The signals through the various networks and the signals on network line 220 and through communication interface 218, which carry the digital data to and from computer system 200, are exemplary forms of carrier waves transporting the information.

Computer system 200 can send messages and receive data, including program codes, through the network(s), network line 220, and communication interface 218. In the Internet example, a server 230 might transmit a requested code for an application program through Internet 228, ISP 226, local network 222, and communication interface 218.

The received code may be executed by processor 204 as it is received, and/or stored in storage device 210, or other non-volatile storage for later execution. In this manner, computer system 200 may obtain an application code in the form of a carrier wave.

It is understood that the above described computer system has been presented for the purposes of illustration and description only, and any number of alternative computer based implementations can be readily devised by one of ordinary skill in the art, and are suitable for practicing and implementing the invention.

A number of embodiments of the invention have been described. Nevertheless, it will be understood that various modifications may be made without departing from the spirit and scope of the invention. For example, one skilled in the readily acknowledges the plethora of algorithms that may be used to match trade-interests or execute transactions. Also, many embodiments set forth herein have discussed or used terminology found in the SEC rules and regulations now in effect. Changes in the SEC rules and regulations that affect the language used and description herein are intended to be within the scope of the description and claims. Accordingly, other embodiments are within the scope of the following claims.

What is claimed is:

1. A trading system comprising:
a trade-interest entry engine configured to receive a trade-interest and a contra-side trade-interest;
a trade-interest matching engine configured to match trade-interests received by the trade-interest entry engine; and
an alert generating engine.

2. The trading system of claim 1, further comprising an anonymous blind auction engine configured to be activated when the trade-interest matching engine identifies near-complementary trade-interests.

3. The trading system of claim 1, wherein the trade-interest matching engine matches trade-interests that are complementary or near-complementary based on at least one of subject matter and price.

4. The trading system of claim 1, further comprising a back office system configured to perform at least one item selected from the group consisting of clearing a transaction, processing a transaction, monitoring a regulatory requirement, and monitoring a compliance requirement.

5. The trading system of claim 1, further comprising an analytics engine.

6. The trading system of claim 5, wherein the analytics engine is configured to provide at least one service selected from the group consisting of a pre-trade service, a post-trade service, and an algorithmic trade service.

7. The trading system of claim 1, wherein the trading system is configured for trading a security.

8. The trading system of claim 1, wherein the trading system is Internet-based.

9. The trading system of claim 1, wherein the alert generating engine is configured to notify a subscriber that a near-complementary trade-interest exists.

10. The trading system of claim 1, wherein at least one of the trade-interests comprises an indication of interest.

11. The trading system of claim 9, wherein the subscriber notified by the alert generating engine comprises a qualified subscriber.

12. The trading system of claim 9, wherein the alert generating engine notifies the subscriber via at least one item selected from the group consisting of an e-mail, a text message, a phone call, a sound, a color, a graphic, an alphanumeric character, a link, a pop-up, a window, a dialog box, and text.

13. The trading system of claim 1, wherein the anonymous blind auction comprises an anonymous blind Dutch auction.

14. The trading system of claim 1, wherein at least two engines from the group consisting of the trade-interest entry engine, the trade-interest matching engine, the alert generating engine, and the anonymous blind auction engine are combined.

15. The trading system of claim 5, wherein at least two engines from the group consisting of the trade-interest entry engine, the trade-interest matching engine, the alert generating engine, the anonymous blind auction engine, and the analytics engine are combined.

16. The trading system of claim 1, further comprising a mechanism for executing a trade anonymously.

17. The trading system of claim 1, wherein the trade-interest and contra-side trade interest comprise a plurality of trade-interests.

18. The trading system of claim 1, further comprising an algorithmic and optimization engine.

19. The trading system of claim 18, wherein the algorithmic and optimization engine is configured to at least perform one item selected from the group consisting of
route a part of a trade-interest for execution when the trade-interest comprises an order;
process the trade-interest comprising an order and if at least part of the order cannot be processed then route that unprocessed part of the order for execution; and
route at least part of the order for execution at the same time the system processes the order.

20. A trading system comprising:
a trade-interest entry engine configured to receive a trade-interest and a contra-side trade-interest;
a trade-interest matching engine configured to match trade-interests received by the trade-interest entry engine;
an alert generating engine; and
an anonymous blind auction engine configured to be activated when the trade-interest matching engine identifies near-complementary trade-interests.

21. The trading system of claim 20, wherein the trade-interest matching engine matches trade-interests that are complementary or near-complementary based on at least one of subject matter and price.

22. The trading system of claim 20, further comprising a back office system configured to perform at least one item selected from the group consisting of clearing a transaction, processing a transaction, monitoring a regulatory requirement, and monitoring a compliance requirement.

23. The trading system of claim 20, further comprising an analytics engine.

24. The trading system of claim 23, wherein the analytics engine is configured to provide at least one service selected from the group consisting of a pre-trade service, a post-trade service, and an algorithmic trade service.

25. The trading system of claim 20, wherein the trading system is configured for trading a security.

26. The trading system of claim 20, wherein the trading system is Internet-based.

27. The trading system of claim 20, wherein the alert generating engine is configured to notify a subscriber that a near-complementary trade-interest exists.

28. The trading system of claim 27, wherein the subscriber notified by the alert generating engine comprises a qualified subscriber.

29. The trading system of claim 20, wherein the at least one of the near-complementary trade-interests comprises an indication of interest.

30. The trading system of claim 20, wherein the alert generating engine notifies the subscriber via at least one item selected from the group consisting of an e-mail, a text message, a phone call, a sound, a color, a graphic, an alphanumeric character, a link, a pop-up, a window, a dialog box, and text.

31. The trading system of claim 20, wherein the anonymous blind auction comprises an anonymous blind Dutch auction.

32. The trading system of claim 20, wherein at least two engines from the group consisting of the trade-interest entry engine, the trade-interest matching engine, the alert generating engine, and the anonymous blind auction engine are combined.

33. The trading system of claim 23, wherein at least two engines from the group consisting of the trade-interest entry engine, the trade-interest matching engine, the alert generating engine, the anonymous blind auction engine, and the analytics engine are combined.

34. The trading system of claim 20, further comprising a mechanism for executing a trade anonymously.

35. The trading system of claim 20, wherein the trade-interest and contra-side trade interest comprise a plurality of trade-interests.

36. The trading system of claim 20, further comprising an algorithmic and optimization engine.

37. The trading system of claim 36, wherein the algorithmic and optimization engine is configured to at least perform one item selected from the group consisting of
route a part of a trade-interest for execution when the trade-interest comprises an order;
process the trade-interest comprising an order and if at least part of the order cannot be processed then route that unprocessed part of the order for execution; and
route at least part of the order for execution at the same time the system processes the order.

38. A trading system comprising:
a trade-interest entry engine configured to receive a plurality of trade-interests, wherein at least one trade-interest comprises an indication of interest;
a trade-interest matching engine configured to match trade-interests received by the trade-interest entry engine;
an alert generating engine; and
an anonymous blind auction engine configured to be activated when the trade-interest matching engine matches an indication of interest with a contra-side trade-interest.

39. The trading system of claim 38, wherein the trade-interest matching engine matches trade-interests that are complementary or near-complementary.

40. The trading system of claim 38, further comprising a back office system configured to perform at least one item selected from the group consisting of clearing a transaction, processing a transaction, monitoring a regulatory requirement, and monitoring a compliance requirement.

41. The trading system of claim 38, wherein the alert generating engine provides an alert to a subscriber who has a contra-side trade-interest to the indication of interest.

42. The trading system of claim 38, wherein the alert generating engine notifies a subscriber via at least one item selected from the group consisting of an e-mail, a text message, a phone call, a sound, a color, a graphic, an alphanumeric character, a link, a pop-up, a window, a dialog box, and text.

43. The trading system of claim 38, further comprising an analytics engine.

44. The trading system of claim 43, wherein the analytics engine is configured to provide at least one service selected from the group consisting of a pre-traded service, a post-traded service, and an algorithmic trade service.

45. The trading system of claim 38, wherein the trading system is configured for trading a security.

46. The trading system of claim 38, wherein at least two engines from the group consisting of the trade-interest entry engine, the trade-interest matching engine, the alert generating engine, and the anonymous blind auction engine are combined.

47. The trading system of claim 43, wherein at least two engines from the group consisting of the trade-interest entry engine, the trade-interest matching engine, the alert generating engine, the anonymous blind auction engine, and the analytics engine are combined.

48. The trading system of claim 38, wherein the trading system is Internet-based.

49. The trading system of claim 38, wherein the anonymous blind auction engine is configured to be activated automatically.

50. The trading system of claim 38, further comprising a mechanism to execute a trade anonymously.

51. The trading system of claim 38, further comprising an algorithmic and optimization engine.

52. The trading system of claim 51, wherein the algorithmic and optimization engine is configured to at least perform one item selected from the group consisting of
route a part of a trade-interest for execution when the trade-interest comprises an order;
process the trade-interest comprising an order and if at least part of the order cannot be processed then route that unprocessed part of the order for execution; and
route at least part of the order for execution at the same time the system processes the order.

53. A trading system comprising:
a trade-interest entry engine configured to receive a trade-interest and a contra-side trade-interest, wherein at least one of the trade-interests is an indication of interest;
a trade-interest matching engine configured to match trade-interests received by the trade-interest entry engine;
an alert generating engine configured to notify a subscriber that a near-complementary trade-interest exists; and
an anonymous blind auction engine configured to be activated when the trade-interest matching engine identifies near-complementary trade-interests.

54. The trading system of claim 53, wherein the trade-interest matching engine matches trade-interests that are complementary or near-complementary.

55. The trading system of claim 53, further comprising a back office system configured to perform at least one item selected from the group consisting of clearing a transaction, processing a transaction, monitoring a regulatory requirement, and monitoring a compliance requirement.

56. The trading system of claim 53, further comprising an analytics engine.

57. The trading system of claim 56, wherein the analytics engine is configured to provide at least one service selected from the group consisting of a pre-trade service, a post-trade service, and an algorithmic trade service.

58. The trading system of claim 53, wherein the trading system is configured for trading a security.

59. The trading system of claim 53, wherein the trading system is Internet-based.

60. The trading system of claim 53, wherein the subscriber notified by the alert generating engine comprises a qualified subscriber.

61. The trading system of claim 53, wherein the matchable trade-interest comprises the indication of interest.

62. The trading system of claim 53, wherein the alert generating engine notifies the subscriber via at least one item selected from the group consisting of an e-mail, a text message, a phone call, a sound, a color, a graphic, an alphanumeric character, a link, a pop-up, a window, a dialog box, and text.

63. The trading system of claim 53, wherein the anonymous blind auction comprises an anonymous blind Dutch auction.

64. The trading system of claim 53, wherein at least two engines from the group consisting of the trade-interest entry engine, the trade-interest matching engine, the alert generating engine, and the anonymous blind auction engine are combined.

65. The trading system of claim 57, wherein at least two engines from the group consisting of the trade-interest entry engine, the trade-interest matching engine, the alert generating engine, the anonymous blind auction engine, and the analytics engine are combined.

66. The trading system of claim 53, wherein the anonymous blind auction engine is configured to be activated automatically.

67. The trading system of claim 53, further comprising a mechanism for executing a trade anonymously.

68. The trading system of claim 53, wherein the trade-interest and contra-side trade interest each comprise a plurality of trade-interests.

69. The trading system of claim 53, further comprising an algorithmic and optimization engine.

70. The trading system of claim 69, wherein the algorithmic and optimization engine is configured to at least perform one item selected from the group consisting of
route a part of a trade-interest for execution when the trade-interest comprises an order;
process the trade-interest comprising an order and if at least part of the order cannot be processed then route that unprocessed part of the order for execution; and
route at least part of the order for execution at the same time the system processes the order.

71. A method of trading a good comprising:
receiving a trade-interest and a contra-side trade-interest;
determining whether the trade-interest and the contra-side trade-interest are matchable;
generating an alert when at least one of the matchable trade-interest and contra-side trade interest comprises an indication of interest; and
activating an anonymous blind auction to trade the good.

72. The method of claim 71, wherein the trade-interests are received via a trade-interest entry engine.

73. The method of claim 71, wherein the determination step uses a trade-interest matching engine.

74. The method of claim 71, wherein the alert is generated via an alert generating engine.

75. The method of claim 71, wherein the anonymous blind auction is activated via an anonymous blind auction engine.

76. The method of claim 71, wherein the determination step matches trade-interests that are complementary or near-complementary.

77. The method of claim 71, wherein matchable comprises complementary or near-complementary.

78. The method of claim 71, wherein the activating step is automatic.

79. The method of claim 71, further comprising using an analytics engine.

80. The method of claim 79, wherein the analytics engine provides at least one service selected from the group consisting of a pre-trade service, a post-trade service, and an algorithmic trade service.

81. The method claim 71, wherein the good is a security.

82. The method of claim 71, wherein the trade-interest and contra-side trade-interest are entered by an entity or person.

83. The method of claim 71, wherein the anonymous blind auction comprises an anonymous blind Dutch auction.

84. The method of claim 71, further comprising at least one process selected from the group consisting of clearing a transaction, processing a transaction, monitoring a regulatory requirement, and monitoring a compliance requirement.

85. The method of claim 71, wherein at least two engines from the group consisting of the trade-interest entry engine, the trade-interest matching engine, the alert generating engine, and the anonymous blind auction engine are combined.

86. The method of claim 79, wherein at least two engines from the group consisting of the trade-interest entry engine, the trade-interest matching engine, the alert generating engine, the anonymous blind auction engine, and the analytics engine are combined.

87. The method of claim 71, further comprising executing a trade anonymously when trade-interests that are complementary orders are matched.

88. The method of claim 71, further comprising generating the alert when near-complementary trade-interests are matched.

89. The method system of claim 71, wherein the trade-interest and contra-side trade interest each comprise a plurality of trade-interests.

90. The trading system of claim 71, further comprising performing at least one item selected from the group consisting of
routing a part of a trade-interest for execution when the trade-interest comprises an order;
processing the trade-interest comprising an order and if part of the order cannot be processed then routing that part of the order for execution; and
routing part of the trade-interest comprising an order for execution at the same time the system processes the order.

91. The method of claim 90, wherein the step of performing uses an algorithmic and optimization engine.

92. A method of trading a good comprising:
receiving a first trade-interest for the good in the form of an order from a subscriber via a trade-interest entry engine;
receiving a contra-side trade-interest from a second subscriber via the trade-interest entry engine, wherein the contra-side trade-interest comprises an indication of interest for the good;
determining whether the trade-interest and the contra-side trade-interest match through use of a trade-interest matching engine;
providing an alert, via an alert generating engine, to at least one of the first subscriber and the second subscriber when the trade-interest and the contra-side trade-interest are matchable; and
providing an opportunity for the first and second subscriber to participate in an anonymous blind auction to trade the good.

93. The method of claim 92, wherein the determination step matches trade-interests that are complementary or near-complementary.

94. The method of claim 92, wherein matchable comprises complementary or near-complementary.

95. The method of claim 92, further comprising using an analytics engine.

96. The method of claim 95, wherein the analytics engine provides at least one service selected from the group consisting of a pre-trade service, a post-trade service, and an algorithmic trade service.

97. The method claim 92, wherein the good is a security.

98. The method of claim 92, wherein the first subscriber and the second subscriber are an entity or person.

99. The method of claim 92, wherein the anonymous blind auction comprises an anonymous blind Dutch auction.

100. The method of claim 92, further comprising at least one process selected from the group consisting of clearing a transaction, processing a transaction, monitoring a regulatory requirement, and monitoring a compliance requirement.

101. The method of claim 92, wherein at least two engines from the group consisting of the trade-interest entry engine, the trade-interest matching engine, the alert generating engine, and the anonymous blind auction engine are combined.

102. The method of claim 95, wherein at least two engines from the group consisting of the trade-interest entry engine, the trade-interest matching engine, the alert generating engine, the anonymous blind auction engine, and the analytics engine are combined.

103. The method of claim 92, further comprising executing a trade anonymously when the contra-side trade-interest becomes a complementary order to the first trade-interest.

104. The method system of claim 92, wherein the trade-interest and contra-side trade interest each comprise a plurality of trade-interests.

105. The trading system of claim 92, further comprising performing at least one item selected from the group consisting of
routing a part of a trade-interest for execution when the trade-interest comprises an order;
processing the trade-interest comprising an order and if part of the order cannot be processed then routing that part of the order for execution; and
routing part of the trade-interest comprising an order for execution at the same time the system processes the order.

106. The method of claim 105, wherein the step of performing uses an algorithmic and optimization engine.

107. A trading system comprising:
a trade-interest entry engine configured to receive a plurality of trade interests;
a trade-interest matching engine configured to match trade-interests received by the trade-interest entry engine;
an alert generating engine configured to notify a subscriber that a near-complementary trade-interest exists;
an anonymous blind auction engine configured to be activated when the trade-interest matching engine identifies near-complementary trade-interests;
a mechanism for executing a trade configured to be activated when the trade-interest matching engine identifies complementary trade-interests that are orders.

108. The trading system of claim 107, wherein the trade-interest matching engine matches trade-interests that are complementary or near-complementary based on at least one of subject matter and price.

109. The trading system of claim 107, further comprising a back office system configured to perform at least one item selected from the group consisting of clearing a transaction, processing a transaction, monitoring a regulatory requirement, and monitoring a compliance requirement.

110. The trading system of claim 107, further comprising an analytics engine.

111. The trading system of claim 110, wherein the analytics engine is configured to provide at least one service selected from the group consisting of a pre-trade service, a post-trade service, and an algorithmic trade service.

112. The trading system of claim 107, wherein the trading system is configured for trading a security.

113. The trading system of claim 107, wherein the trading system is Internet-based.

114. The trading system of claim 107, wherein at least one of the trade-interests comprises an indication of interest.

115. The trading system of claim 107, wherein the subscriber notified by the alert generating engine comprises a qualified subscriber.

116. The trading system of claim 107, wherein the alert generating engine notifies the subscriber via at least one item selected from the group consisting of an e-mail, a text message, a phone call, a sound, a color, a graphic, an alphanumeric character, a link, a pop-up, a window, a dialog box, and text.

117. The trading system of claim 107, wherein the anonymous blind auction comprises an anonymous blind Dutch auction.

118. The trading system of claim 107, wherein at least two engines from the group consisting of the trade-interest entry engine, the trade-interest matching engine, the alert generating engine, and the anonymous blind auction engine are combined.

119. The trading system of claim 110, wherein at least two engines from the group consisting of the trade-interest entry engine, the trade-interest matching engine, the alert generating engine, the anonymous blind auction engine, and the analytics engine are combined.

120. The trading system of claim 107, wherein the plurality of trade-interests comprise trade-interests and contra-side trade-interests.

121. The trading system of claim 107, further comprising an algorithmic and optimization engine.

122. The trading system of claim 121, wherein the algorithmic and optimization engine is configured to at least perform one item selected from the group consisting of
route a part of a trade-interest for execution when the trade-interest comprises an order;
process the trade-interest comprising an order and if at least part of the order cannot be processed then route that unprocessed part of the order for execution; and
route at lease part of the order for execution at the same time the system processes the order.

123. A method of trading a good comprising:
receiving a trade-interest and a contra-side trade-interest;
determining whether the trade-interest and the contra-side trade-interest are matchable;
generating an alert when at least one of the matchable trade-interest and contra-side trade interest comprises an indication of interest;
activating an anonymous blind auction to trade the good when at least one of the matchable trade-interest and contra-side trade interest comprises an indication of interest; and
executing a trade anonymously when trade-interests that are complementary orders are matched.

124. The method of claim 123, wherein the trade-interests are received via a trade-interest entry engine.

125. The method of claim 123, wherein the determination step uses a trade-interest matching engine.

126. The method of claim 123, wherein the alert is generated via an alert generating engine.

127. The method of claim 123, wherein the anonymous blind auction is activated via an anonymous blind auction engine.

128. The method of claim 123, wherein the determination step matches trade-interests that are complementary or near-complementary.

129. The method of claim 123, wherein matchable comprises complementary or near-complementary.

130. The method of claim 123, wherein the activating step is automatic.

131. The method of claim 123, further comprising using an analytics engine.

132. The method of claim 131, wherein the analytics engine provides at least one service selected from the group consisting of a pre-trade service, a post-trade service, and an algorithmic trade service.

133. The method claim 123, wherein the good is a security.

134. The method of claim 123, wherein the trade-interest and contra-side trade-interest are entered by an entity or person.

135. The method of claim 123, wherein the anonymous blind auction comprises an anonymous blind Dutch auction.

136. The method of claim 123, further comprising at least one process selected from the group consisting of clearing a transaction, processing a transaction, monitoring a regulatory requirement, and monitoring a compliance requirement.

137. The method of claim 123, wherein at least two engines from the group consisting of the trade-interest entry engine, the trade-interest matching engine, the alert generating engine, and the anonymous blind auction engine are combined.

138. The method of claim 131, wherein at least two engines from the group consisting of the trade-interest entry engine, the trade-interest matching engine, the alert generating engine, the anonymous blind auction engine, and the analytics engine are combined.

139. The method of claim 123, further wherein the execution of the trade occurs via a mechanism for executing trades.

140. The method system of claim 123, wherein the trade-interest and contra-side trade interest each comprise a plurality of trade-interests.

141. The trading system of claim 123, further comprising performing at least one item selected from the group consisting of
routing a part of a trade-interest for execution when the trade-interest comprises an order;
processing the trade-interest comprising an order and if part of the order cannot be processed then routing that part of the order for execution; and
routing part of the trade-interest comprising an order for execution at the same time the system processes the order.

142. The method of claim 141, wherein the step of performing uses an algorithmic and optimization engine.
